(19) United States
(12) Patent Application Publication
(10) Pub. No.: US 2008/0018832 A1
(43) Pub. Date: Jan. 24, 2008

(54) POLARIZATION FILM USING CARBON NANO TUBE AND A METHOD OF MANUFACTURING THE SAME

(76) Inventors: Seoung Ho Lee, Gyeonggi-do (KR); Sang Gon Lee, Chungcheongbuk-do (KR); Ung Sang Lee, Chungcheongbuk-do (KR)

Correspondence Address: BIRCH STEWART KOLASCH & BIRCH, PO BOX 747, FALLS CHURCH, VA, 22040-0747, US

(21) Appl. No.: 11/759,811

(22) Filed: Jun. 7, 2007

(30) Foreign Application Priority Data
Jul. 20, 2006 (KR) 10-2006-0067907

(51) Int. Cl. G02F 1/1335; B29D 7/01; G02B 5/30

(52) U.S. Cl. 349/96; 264/1.34; 359/485; 977/742

(57) ABSTRACT

The present invention relates to a polarization film using carbon nano tube and a method of manufacturing the same. The polarization film comprises a base film; and a polarizing layer including carbon nano tube and disposed on the base film.

### CROSS-REFERENCE TO A RELATED APPLICATION

This application claims priority from Korean Patent Application No. 10-2006-0067907 filed on Jul. 20, 2006, the content of which is incorporated herein by reference in its entirety.

### BACKGROUND

1. Field

The present invention relates to a polarization film using carbon nano tube. The present invention also relates to a method of manufacturing the polarization film.

2. Background

As well known in the art, polarization film is a polarizing de,ice to obtain a polarized light by transmitting only a light having a certain direction of oscillating surface and absorbing other lights, in the natural light having 360°, all directions of oscillating surface.

Generally, the polarization film uses a device dividing a polarizing light perpendicular to an incident plane and a polarizing light parallel to the incident plane by using polarizer having light absorption property. A straight type of polarization light and an oval type of polarization light are obtained by polarizer.

For uniform polarization and highly efficient polarization, proper material selection and film processing are needed depending on usage.

In short, the polarization film is formed by using a lot of films, like a PVA film, TAC films, a compensation film, etc.

Therefore, the time and cost for manufacturing films of each layer in the polarization film are increased, and the thickness of polarization film is increased.

These contents are incorporated by reference herein where appropriate for appropriate teachings of additional or alternative details, features and/or technical background.

### BRIEF DESCRIPTION OF THE DRAWINGS

Preferable embodiments of the present invention will be described in detail with reference to the following drawings in which same reference numerals refer to same elements wherein:

FIG. 1 is a cross-sectional view of the liquid crystal display device according to one embodiment of the present invention;

FIGS. 2A and 2B are a disassembling perspective view and a cross sectional view of the polarization film according to one embodiment of the present invention;

FIGS. 3A to 3E are views of manufacturing processes of the polarization film according to the present invention; and

FIG. 4 is a graph illustrating polarization property of the polarization film of the present invention.

### DETAILED DESCRIPTION OF THE INVENTION

One object of the present invention is to provide a method of manufacturing the polarization film made of a material containing carbon nano tube, whereby the process can be simpler and the manufacturing costs can be reduced.

Another object of the present invention is to provide a polarization film using carbon nano tube having good polarization property.

Further scope of applicability of the present invention will become apparent from the detailed description given hereinafter. However, it should be understood that the detailed description, and specific examples indicating preferred embodiments of the invention, are given by way of illustration only, since various changes and modifications within the spirit and scope of the invention will become apparent to those skilled in the art from the detailed description.

In the following drawings, same reference numbers will be used to refer to same or similar parts through all the embodiments. In addition, detailed descriptions for identical parts are not repeated.

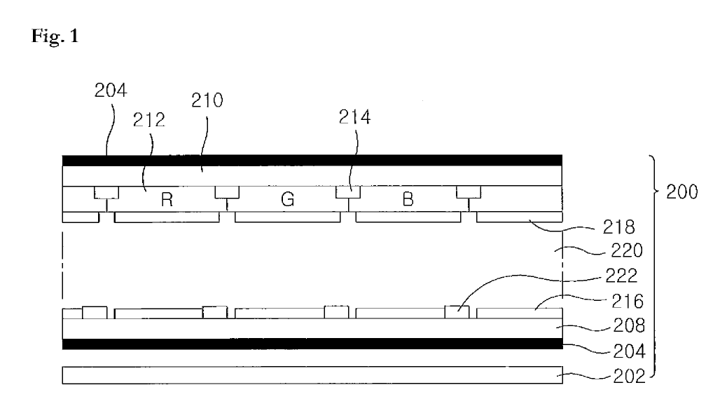

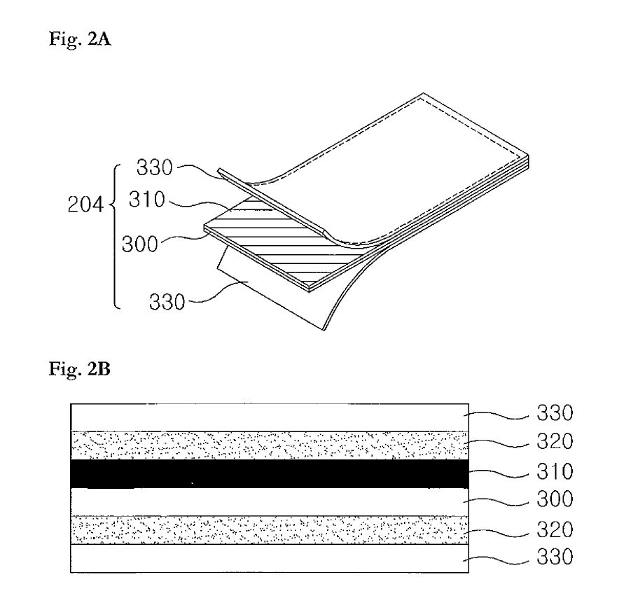

FIG. 1 is a cross-sectional view of the liquid crystal display device according to one embodiment of the present invention. FIGS. 2A and 2B are a disassembling perspective view and a cross-sectional view of die polarization film according to one embodiment of the present invention.

Referring to FIG. 1, the liquid crystal display device (hereinafter “LCD device”) comprises a liquid crystal display (LCD) panel 200 and a backlight unit 202.

The LCD panel 200 comprises upper and lower polarization films 204, a lower substrate 208, an upper substrate 210, a color filter layer 212, a black matrix layer 214, pixel electrodes 216, a common electrode 218, a liquid crystal layer 220 and TFT array 222.

The color filter layer 212 includes color filters which correspond to red color R, green color G and blue color B, and generates images corresponding to red, green and blue colors when a light is provided thereto.

The TFT array 222 is a switching device for switching the pixel electrodes 216.

The common electrode 218 and the pixel electrodes 216 arrange liquid crystal molecules in the liquid crystal layer 220 according to applied voltages.

The liquid crystal layer 220 consists of a plurality of liquid crystal molecules that are arranged according to voltage differences generated between the pixel electrodes 216 and the common electrode 218. Thus, a light provided from the backlight unit 202 is incident to the color filter layer 212.

The backlight unit 202 is disposed at a lower part of the LCD panel 200 to provide a light, for example white light.

The upper and lower polarization films 204 each are disposed outside of the upper substrate 210 and the lower substrate 208, to cross each other at an angle of 90°, and transmit a part of incident natural light by polarizing, and absorb or diffuse the other part.

The light generated from the backlight unit 202 is a natural light, and the oscillating direction of tie light has same probability to all directions.

In case the light transmits the lower polarization film 204, the lower polarization film 204 transmits a light oscillating to same direction as polarization axis of the lower polarization film 204, and absorbs or reflects a light oscillating to other directions by using proper medium, thereby making the light oscillating to a specific one direction.

Because the upper and lower polarization films 204 are attached to the upper and lower substrates 210 and 208 so that the polarization axis meets at right angles above and below the liquid crystal layer 220, the intensity of transmitted light can be controlled according to a rotation rate of the polarization axis while the light transmits the liquid crystal layer 220, whereby gray light can be expressed between black and white.

Hereinafter, the construction and method of manufacturing the polarization film 204 performing the above function will be described.

Generally, the polarization film 204 can be classified as halogen polarization film, dye polarization film, metal polarization film, polyvinyl polarization film, infrared ray polarization film, and near ultraviolet ray polarization film. Especially, halogen (iodine based) polarization film and dye polarization film have been commercialized and used in industry.

Referring to FIGS. 2A and 2B, the polarization film 204 of the present invention comprises a base film 300, a polarizing layer 310 and a protecting film 330.

The base film 300 is formed of a transparent material for transmitting an incident light, and the kind of material is not limited thereto.

The polarizing layer 310 is formed by applying a resin on the base film 300 in a certain thickness.

The resin is formed by mixing carbon nano tube, a solvent, and a binder, and dispersing the mixture.

The carbon nano tube is a tube type of new material in which hexagons consisting of six carbons are connected to each other. One carbon atom is connected to the other three carbon atoms to form hexagon. The carbon nano tube constitutes a hollow tube form in which a graphite sheet is round rolled in nano size diameter. It called a nano-tube because the diameter is only dozens of nanometer (nm).

The carbon nano tube's properties like electric property are changed according to the angle of rolling. The carbon nano tube can be classified into a single avail nanotube (SWNT), a multi wall nanotube (MWNT), and a nanotube rope, according to the rolling form.

The carbon nano tube may be manufactured by electric discharging method, laser depositing method, thermochemical gas depositing method and plasma chemical depositing method. Generally, thermochemical gas depositing method and electric discharging method are mainly used.

The carbon nano tube has electric conductivity similar to copper, same thermal conductivity as diamond, and one hundred (100) times higher strength than steel. Conventional carbon fiber may be broken even by only 1% of transformation, but the present carbon nano tube is not broken even by 15% of transformation.

In short, the present carbon nano tube is solid and hollow, and has good chemical stability and high thermal conductivity, and so its physical, mechanical and chemical properties are superior.

Also, the present carbon nano tube is diamagnetic substance. Diamagnetic substance is a material magnetized by outer magnetic field to an opposite direction to the magnetic field. When applying outer magnetic field, the carbon nano tube can be arranged uniformly to the opposite direction to the magnetic field.

And, if the carbon nano tube is arranged in a certain direction by the magnetic field, among an incident light, only a fight oscillating perpendicular to the certain direction of the carbon nano tube can be transmitted.

The solvent may be at least one selected from the group consisting of benzene, toluene and methyl ethyl ketone (MEK).

Also, the binder may be thermosetting resin or ultraviolet ray curing resin.

The protecting film 330 is used for protecting the base film 300 and the polarizing layer 310 before attaching to a finished product, that is, LCD panel 200.

The protecting film 330 is attached to top of the polarizing layer 310 and to bottom of the base film 300. But, it may be attached to only one side, top of the polarizing layer 310 or bottom of the base film 300.

Also, an adhesive layer 320 can be disposed between the protecting film 330 and the polarizing layer 310, or between the base film 300 and the protecting film 330. The adhesive layer 320 is formed for easily attaching the polarization film 204 to the LCD panel 200.

The protecting film 330 uses a PET film with separation treatment so that the protecting film 330 can be easily separated from the adhesive layer 320 when the polarization film 204 is attached to the LCD panel 200.

The protecting film 330 is removed when the polarization film 204 is attached to the LCD device.

Hereinafter, the method of manufacturing the polarization film will be described.

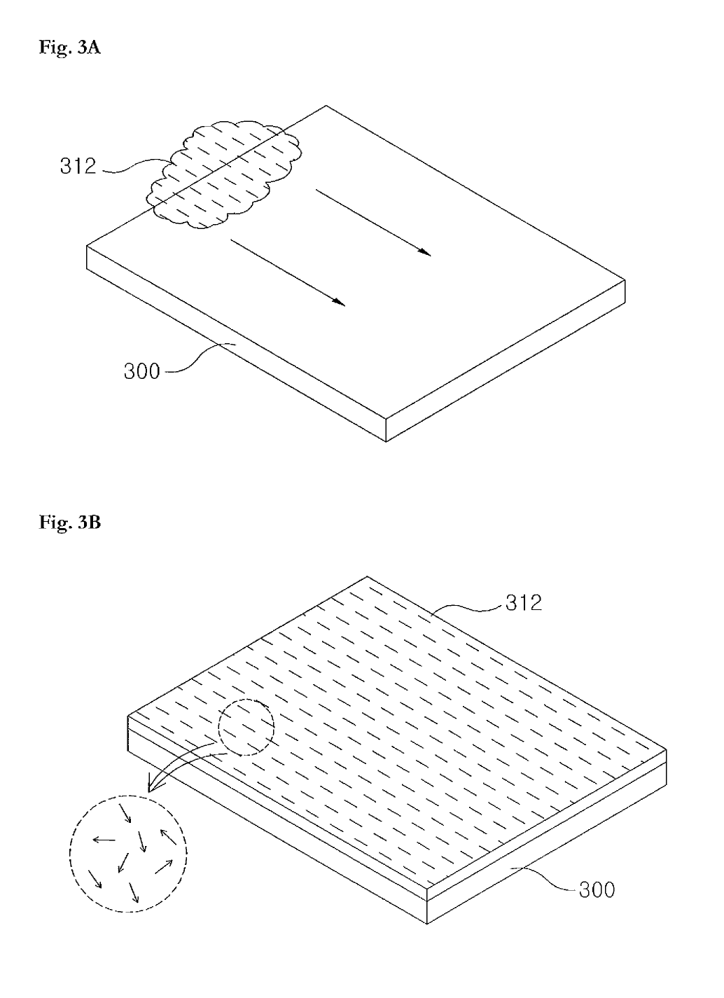

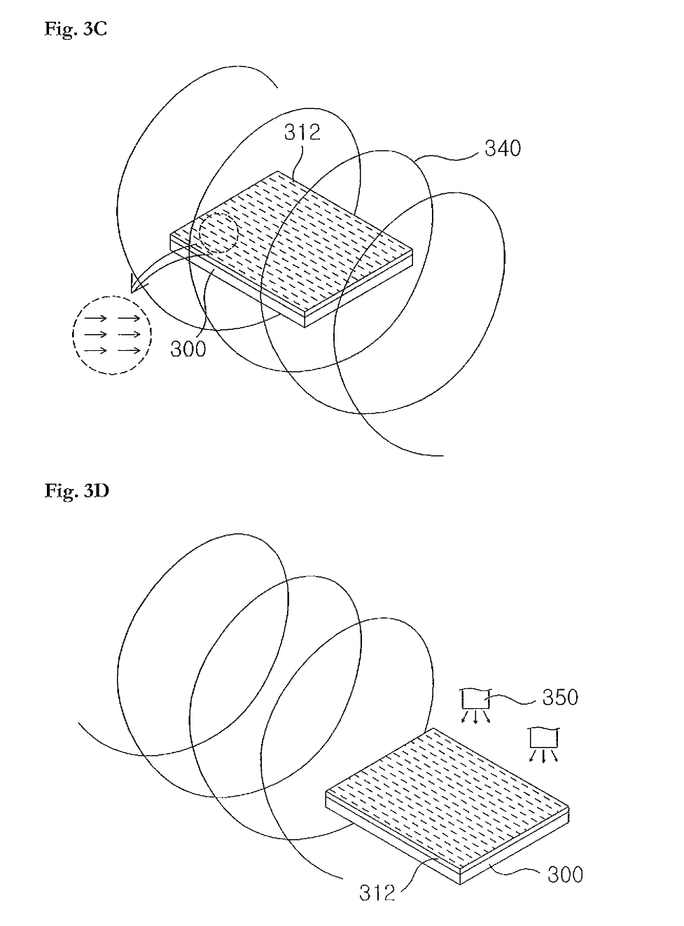

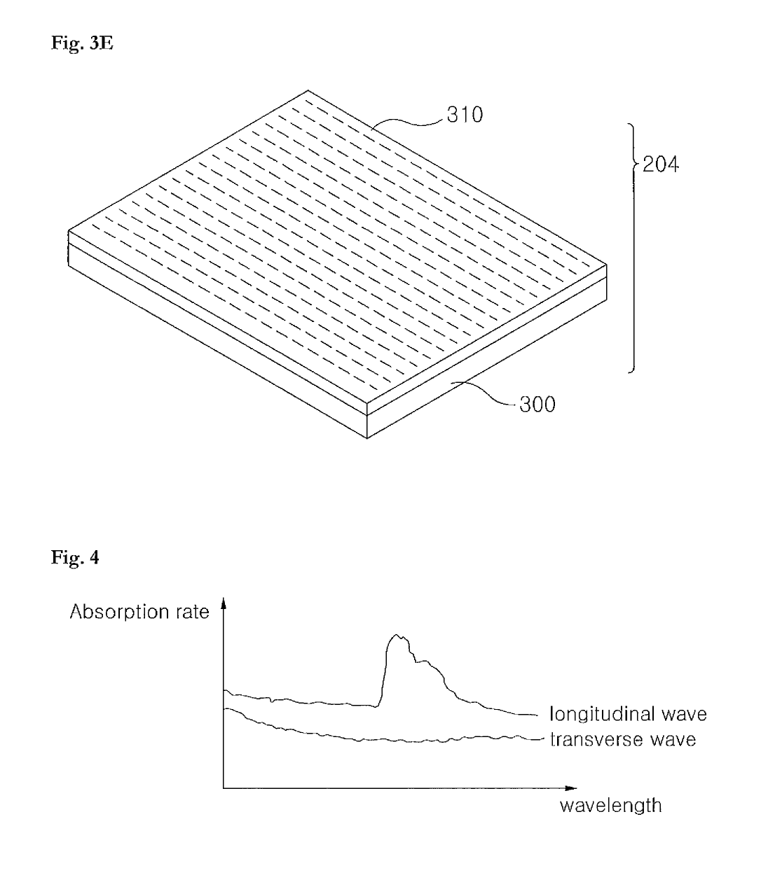

FIGS. 3A to 3E are views of manufacturing processes of the polarization film according to the present invention. And, FIG. 5 is a graph illustrating polarization property of the polarization film of the present invention.

First, referring to FIG. 3A, a resin 312 including the carbon nano tube is applied to the base film 300.

In case of applying the resin 312 in this way, the carbon nano tube in the resin 312 is distributed on the base film 300 without certain direction, as shown in FIG. 3B.

Next, a magnetic field is applied to the resin 312 on the base film 300. To apply the magnetic field, as shown in FIG. 3C, the base film 300 to which the resin 312 is applied is passed through a solenoid coil 340. At this time, a certain magnetic field is continuously applied to the solenoid coil 340.

However, the method of applying the magnetic field to the carbon nano tube in the resin 312 is not limited to the above method of using solenoid coil 340, and permanent magnet can be used. There is no restriction thereto.

By applying the magnetic field, it can be confirmed that the carbon nano tube is arranged in a certain direction by diamagnetic property.

And, as shown in FIG. 3D, the resin 312 is dried at an end of the solenoid coil 340. The drying can be done by heat or ultraviolet ray depending on characteristic of the binder used in the resin 312.

In the drying process, the solvent in the resin 312 is mostly evaporated.

When the drying is finished, as shown in FIG. 3E, a polarizing layer 310 in which the carbon nano tube is in c certain direction is formed.

As shown in FIG. 4, in the polarizing layer 310 manufactured by the above method, it is confirmed that the absorptances of the longitudinal wave and the transverse wave are very different when a light having certain wavelength is incident. That is, most transverse waves are transmitted, and most longitudinal waves are absorbed, but only a certain direction of light is polarized.

However, the polarization film 204 of the present invention can be used not only for the liquid crystal display device, but also for all devices generally used for the polarization film 204, like a camera.

Another embodiment may be achieved in whole or in part by the polarization film comprising a base film; and a polarizing layer including carbon nano tube and disposed on the base film.

Any reference in this specification to “one embodiment,” “an embodiment,” “example embodiment,” etc., means that a particular feature, structure, or characteristic described in connection with the embodiment is included in at least one embodiment of the invention. The appearances of such phases in various places in the specification are not necessarily all referring to same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. Particularly, various variations and modifications are possible in the component parts and/or arrangements within the scope of the disclosure, the drawings, and the appended claims. In addition to variations and modifications in the component parts and/or arrangements, alternative uses will also be apparent to those skilled in the art.

What is claimed is:

1. A polarization film, comprising:
a base film; and
a polarizing layer including carbon nano tube and disposed on the base film.

2. The polarization film of claim 1, wherein the carbon nano tube of the polarizing layer are aligned in one direction.

3. The polarization film of claim 1, wherein the polarizing layer further comprises a binder.

4. The polarization film of claim 3, wherein the binder is thermosetting resin or ultraviolet rays curing resin.

5. The polarization film of claim 1, further comprising:
an adhesive layer disposed on the polarizing layer or the base film.

6. The polarization film of claim 5, further comprising:
a protecting film disposed on the adhesive layer.

7. A liquid crystal display comprising:
a liquid crystal panel;
a backlight unit to illuminate the liquid crystal panel; and
a polarization film disposed adjacent to the liquid crystal panel,
wherein the polarization film comprises
a base film; and
a polarizing layer including carbon nano tube and disposed on the base film.

8. The liquid crystal display of claim 7, wherein the carbon nano tube of the polarizing layer is aligned in one direction.

9. The liquid crystal display of claim 7, wherein the polarizing layer further comprises a binder.

10. The liquid crystal display of claim 9, wherein the binder is thermosetting resin or ultraviolet rays curing resin.

11. The liquid crystal display of claim 7, wherein the polarization film further comprising:
an adhesive layer disposed on the polarizing layer or the base film.

12. The liquid crystal display of claim 11, wherein the polarization film further comprising:
a protecting film disposed on the adhesive layer.

13. A method of manufacturing a polarization film comprising:
(a) applying a resin including carbon nano tube on a base film to form a polarizing layer;
(b) applying a magnetic field to the polarizing layer; and
(c) drying tie polarizing layer while applying the magnetic field to the polarizing layer.

14. The method of claim 13, wherein the resin is a mixture formed by mixing the carbon nano tube with a solvent and a binder.

15. The method of claim 13, wherein the magnetic field is generated from a permanent magnet or a solenoid coil.
